(19) United States
(12) Patent Application Publication
(10) Pub. No.: US 2026/0224987 A1
(43) Pub. Date: Aug. 6, 2026

(54) METHOD, APPARATUS, DEVICE, AND STORAGE MEDIUM FOR EFFECT CREATION

(71) Applicants: Bytedance Technology Ltd., Grand Cayman (KY); Beijing Zitiao Network Technology Co, Ltd., Beijing (CN)

(72) Inventors: Jie MENG, Los Angeles, CA (US); Blake Garrett FUSELIER, Los Angeles, CA (US); Runze ZHANG, Los Angeles, CA (US); Shiyuan LIU, Culver City, CA (US); Runjia TIAN, Los Angeles, CA (US); Jagminder Singh Shergill, Los Angeles, CA (US); Jiamin YUAN, Los Angeles, CA (US); Xiaoran NI, Los Angeles, CA (US); Hai Quang KIM, Los Angeles, CA (US); Priyeshkumar WANI, Los Angeles, CA (US); Felicity Wing Tin YICK, Los Angeles, CA (US); Peilin LI, Los Angeles, CA (US); Lexin TANG, Los Angeles, CA (US); Yulei NIU, Los Angeles, CA (US); Xiaoke HUANG, Culver City, CA (US)

(21) Appl. No.: 19/447,959

(22) Filed: Jan. 13, 2026

(30) Foreign Application Priority Data
Jan. 14, 2025 (CN) 202510061799.3

(51) Int. Cl. A63F 13/537; G06F 40/166; G06F 40/40

(52) U.S. Cl. CPC A63F 13/537; G06F 40/166; G06F 40/40

(57) ABSTRACT

Embodiments of the disclosure relate to a method, an apparatus, a device, and a computer-readable storage medium for effect creation. A method proposed herein includes: receiving an input message of a user via a chat interface with a virtual object; processing, based on a message type of the input message and by using a processing module corresponding to the message type, the input message to generate response content for the input message, the processing module including one of: a question answering module, an effect creation module, or an effect editing module; and providing the response content in the chat interface.

### CROSS-REFERENCE

The present application claims priority to Chinese Patent Application No. 202510061799.3, filed on Jan. 14, 2025, and entitled “METHOD, APPARATUS, DEVICE AND STORAGE MEDIUM FOR EFFECT CREATION”, which is incorporated herein by reference in its entirety.

### FIELD

Example embodiments of the present disclosure generally relate to the field of computers, and in particular, to a method, an apparatus, a device, and a computer-readable storage medium for effect creation.

### BACKGROUND

With the development of computer technologies, the Internet has become an important platform for creating and sharing media content. In the process of creating media content, video effects and picture effects are creation means that users often use in the creation process. Such effects may enrich the media content created by users and make the content more interesting.

### SUMMARY

In a first aspect of the present disclosure, a method for effect creation is provided. The method includes: receiving an input message of a user via a chat interface with a virtual object; processing, based on a message type of the input message and by using a processing module corresponding to the message type, the input message to generate response content for the input message, the processing module including one of: a question answering module, an effect creation module, or an effect editing module; and providing the response content in the chat interface.

In a second aspect of the present disclosure, an apparatus for effect creation is provided. The apparatus includes: a receiving module configured to receive an input message of a user via a chat interface with a virtual object; a generation module configured to process, based on a message type of the input message and by using a processing module corresponding to the message type, the input message to generate response content for the input message, the processing module including one of: a question answering module, an effect creation module, or an effect editing module; and a provision module configured to provide the response content in the chat interface.

In a third aspect of the present disclosure, an electronic device is provided. The device includes at least one processor; and at least one memory, the at least one memory being coupled to the at least one processor and storing instructions executable by the at least one processor, the instructions, when executed by the at least one processor, cause the device to perform the method of the first aspect.

In a fourth aspect of the present disclosure, a computer-readable storage medium is provided. The computer-readable storage medium has a computer program stored thereon which is executable by a processor to perform the method of the first aspect.

It would be appreciated that the content described in the Summary section of the present disclosure is neither intended to limit key or essential features of embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of embodiments of the present disclosure will become more apparent in combination with the drawings and with reference to the following detailed description. In the drawings, the same or similar reference symbols refer to the same or similar elements, where:

FIG. 1 shows a schematic diagram of an example environment in which embodiments according to the present disclosure may be implemented;

FIG. 2A to FIG. 2C show example interfaces for example effect creation according to some embodiments of the present disclosure;

FIG. 3 shows an example system according to some embodiments of the present disclosure;

FIG. 4 shows an example process of generating response content according to some embodiments of the present disclosure;

FIG. 5 shows an example process of creating an effect according to some embodiments of the present disclosure;

FIG. 6 shows an example process of editing an effect according to some embodiments of the present disclosure;

FIG. 7 shows a flowchart of an example process of effect creation according to some embodiments of the present disclosure;

FIG. 8 shows a schematic structural block diagram of an example apparatus for effect creation according to some embodiments of the present disclosure; and

FIG. 9 shows a block diagram of an electronic device capable of implementing multiple embodiments of the present disclosure.

### DETAILED DESCRIPTION

Embodiments of the present disclosure will be described in more detail below with reference to the drawings. Although some embodiments of the present disclosure are shown in the drawings, it would be appreciated that the present disclosure may be implemented in various forms and should not be construed as limited to the embodiments set forth herein. Instead, these embodiments are provided for a more thorough and complete understanding of the present disclosure. It would be appreciated that the drawings and embodiments of the present disclosure are only used for illustrative purposes and are not intended to limit the scope of protection of the present disclosure.

It should be noted that the titles of any sections/subsections provided herein are not restrictive. Various embodiments are described throughout this article, and any type of embodiment may be included under any section/subsection. In addition, the embodiments described in any section/subsection may be combined with any other embodiments described in the same section/subsection and/or different sections/subsections in any manner.

In the description of the embodiments of the present disclosure, the term “include/comprise” and similar terms thereto should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other definitions, either explicit or implicit, may be included below. The terms “first”, “second”, etc. may refer to different or same objects. Other definitions, either explicit or implicit, may be included below.

The embodiments of the present disclosure may involve user data, data acquisition and/or use, and the like. These aspects all comply with the corresponding laws, regulations and related provisions. In the embodiments of the present disclosure, all data collection, acquisition, processing, machining, forwarding, use, etc. are carried out on the premise that the user is aware of and confirms. Accordingly, when implementing the embodiments of the present disclosure, the user should be informed of the type, range of use, use scenarios, etc. of the data or information that may be involved and the authorization of the user should be obtained through appropriate means according to relevant laws and regulations. The specific manner of informing and/or authorizing may vary according to actual situations and application scenarios, and the scope of the present disclosure is not limited in this regard.

If the solutions in this specification and the embodiments involve personal information processing, the processing will be carried out on the premise that there is a legal basis (for example, the consent of the personal information subject is obtained, or it is necessary to perform a contract, etc.), and will only be carried out within the scope of regulations or agreements. If the user refuses to process personal information other than the necessary information required for the basic functions, it will not affect the user's use of the basic functions.

As mentioned above, video effects and picture effects are manners for creation that users often use in the creation process. Such effects may enrich the media content created by users and make the content more interesting. Traditionally, users need to spend more time learning how to use effect creation tools, which makes effect creation a more complicated process for ordinary users.

Embodiments of the present disclosure provide a solution for effect creation. The solution includes: receiving an input message of a user via a chat interface with a virtual object; processing, based on a message type of the input message and by using a processing module corresponding to the message type, the input message to generate response content for the input message, the processing module including one of: a question answering module, an effect creation module, or an effect editing module; and providing the response content in the chat interface.

In this way, embodiments of the present disclosure are able to use a unified chat interaction manner to support multiple types of effect processing requests, thereby improving the unity of interaction and the efficiency of creating effects.

Various example implementations of the solution will be described in detail below in further conjunction with the drawings.

### Example Environment

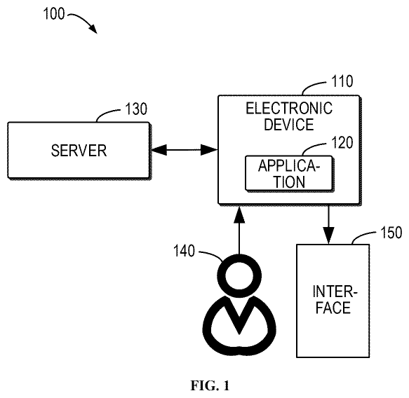

FIG. 1 shows a schematic diagram of an example environment 100 in which embodiments of the present disclosure may be implemented. As shown in FIG. 1, the example environment 100 may include an electronic device 110.

In the example environment 100, the electronic device 110 may run an application 120 supporting interface interaction. The application 120 may be any appropriate type of application for interface interaction, examples of which may include but are not limited to an effect editing application. A user 140 may interact with the application 120 via the electronic device 110 and/or its attached device.

In the environment 100 of FIG. 1, if the application 120 is active, the electronic device 110 may present an interface 150 for supporting interface interaction through the application 120.

In some embodiments, the electronic device 110 communicates with a server 130 to implement the provision of services for the application 120. The electronic device 110 may be any type of mobile terminal, fixed terminal or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the foregoing, including the accessories and peripherals of these devices or any combination thereof. In some embodiments, the electronic device 110 may also support any type of user-specific interface (such as “wearable” circuitry, etc.).

The server 130 may be an independent physical server, a server cluster or a distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server 130 may include, for example, a computing system/server, such as a mainframe, an edge computing node, a computing device in a cloud environment, and the like. The server 130 may provide backstage services for the application 120 supporting a virtual scene in the electronic device 110.

A communication connection may be established between the server 130 and the electronic device 110. The communication connection may be established by wired or wireless means. The communication connection may include but is not limited to a Bluetooth connection, a mobile network connection, a Universal Serial Bus (USB) connection, a Wireless Fidelity (WiFi) connection, etc., and the embodiments of the present disclosure are not limited in this regard. In the embodiments of the present disclosure, the server 130 and the electronic device 110 may implement signaling interaction through the communication connection therebetween.

It would be appreciated that the structures and functions of the elements in the environment 100 are described for illustrative purposes only, without suggesting any limitation to the scope of the present disclosure.

Some example embodiments of the present disclosure will be described below with continued reference to the drawings.

### Example Interaction

The process of effect creation according to embodiments of the present disclosure will be described below with reference to the drawings.

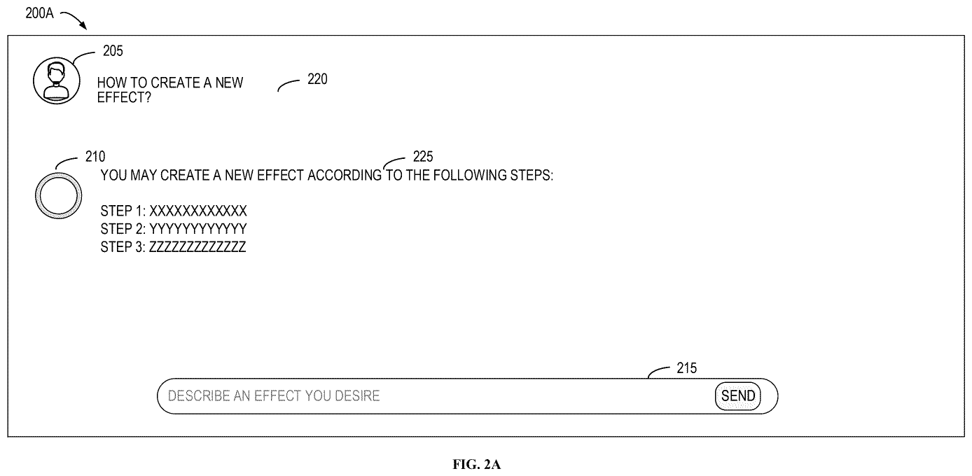

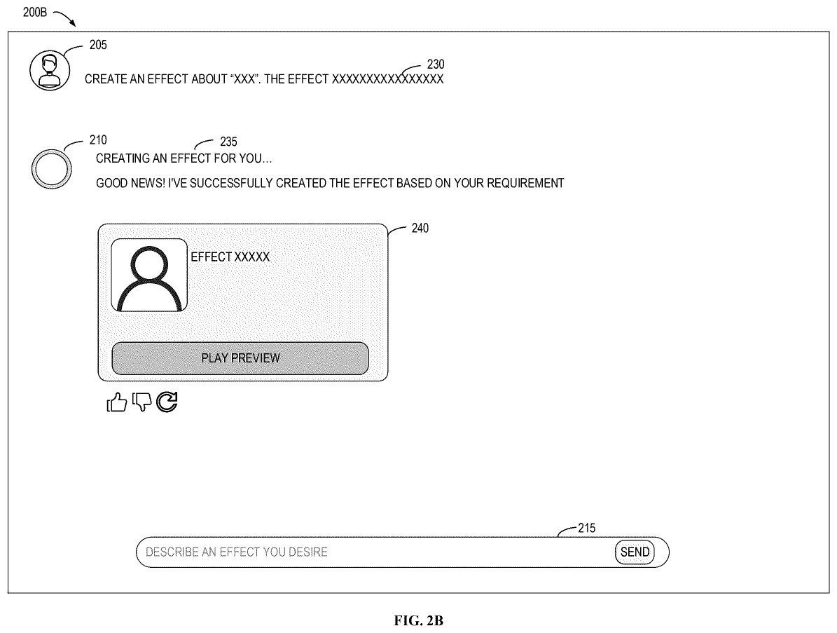

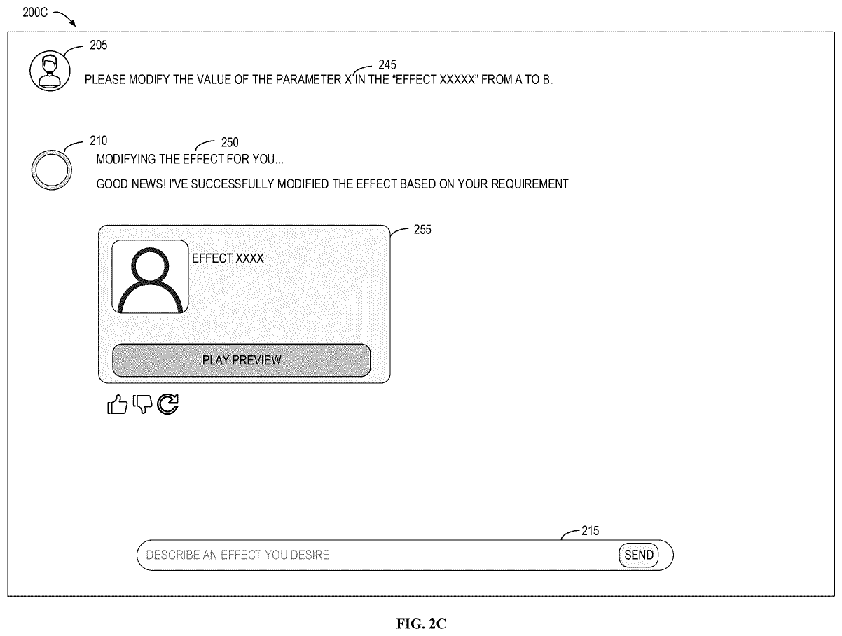

FIG. 2A to FIG. 2C show example interfaces 200A to 200C according to some embodiments of the present disclosure. The interface 200A to interface 200C may be provided by the electronic device 110 shown in FIG. 1, for example.

As shown in FIG. 2A, the interface 200A may be, for example, a chat interface between a user 205 and a virtual object 210. In some embodiments, the virtual object 210 may include any appropriate processing entity that supports generation and/or editing of effects through prompts or the like. In some scenarios, the virtual object 210 may also be referred to as a virtual entity, examples of which may include but are not limited to an agent, a bot, or other processing entities that support triggering effect editing through chat. Such a virtual object may be implemented by using an appropriate machine learning mode, for example, to generate and/or edit effects accordingly based on received prompts. The present disclosure is not intended to limit the specific construction manner of the virtual object.

In some embodiments, as shown in FIG. 2A, the chat interface 200A may include a message display area and an input control 215. The input control 202 may be used to input any appropriate type of message sent to the virtual object 210, such as a text message, a voice message, etc.

In some embodiments, the input message from the user 205 may be directly provided to the virtual object 210, or may be provided to the virtual object 210 after appropriate processing, as a corresponding prompt.

The application 120 may use an effect creation system to generate response content for the input message from the user. In some embodiments, the application 120 may support the user to initiate different types of tasks by using a unified chat interaction, such as a question answering task, an effect generation task, or an effect editing task.

As shown in FIG. 2A, the electronic device 110 may obtain an input message 220 from the user 205 via the input control 215, for example. Taking FIG. 2A as an example, the input message 220 may correspond to a first message type, for example. The first message type may indicate that the input message 220 includes a question to be answered, for example, “How to create a new effect?”

As shown in FIG. 2A, the application 120 may use a question answering module in the effect creation system to process the input message 220 and generate corresponding response content 225. As an example, the response content 225 may include an answer to the question, for example, specific steps involved in creating a new effect.

FIG. 2B shows an interaction scenario according to some other embodiments of the present disclosure. As shown in FIG. 2B, the electronic device 110 may obtain an input message 230 from the user 205 via the input control 215, for example. Taking FIG. 2B as an example, the input message 230 may correspond to a second message type, for example. The second message type may indicate that the input message 230 is associated with an effect creation request. For example, the input message 230 may describe a request of the user to create a specific effect.

As shown in FIG. 2B, the application 120 may use an effect creation module in the effect creation system to process the input message 230 and generate corresponding response content. As an example, the response content may include a reply text 235 and an effect 240 generated based on the input message 230.

FIG. 2C shows an interaction scenario according to some further embodiments of the present disclosure. As shown in FIG. 2C, the electronic device 110 may obtain an input message 245 from the user 205 via the input control 215, for example. Taking FIG. 2C as an example, the input message 245 may correspond to a third message type, for example. The third message type may indicate that the input message 245 is associated with an effect editing request. For example, the input message 245 may describe a request of the user to modify an existing effect.

As shown in FIG. 2C, the application 120 may use an effect editing module in the effect creation system to process the input message 245 and generate corresponding response content. As an example, the response content may include a reply text 250 and an edited effect 255.

How to use a unified chat interaction to implement the processing of different types of effect tasks will be introduced below.

### Example System

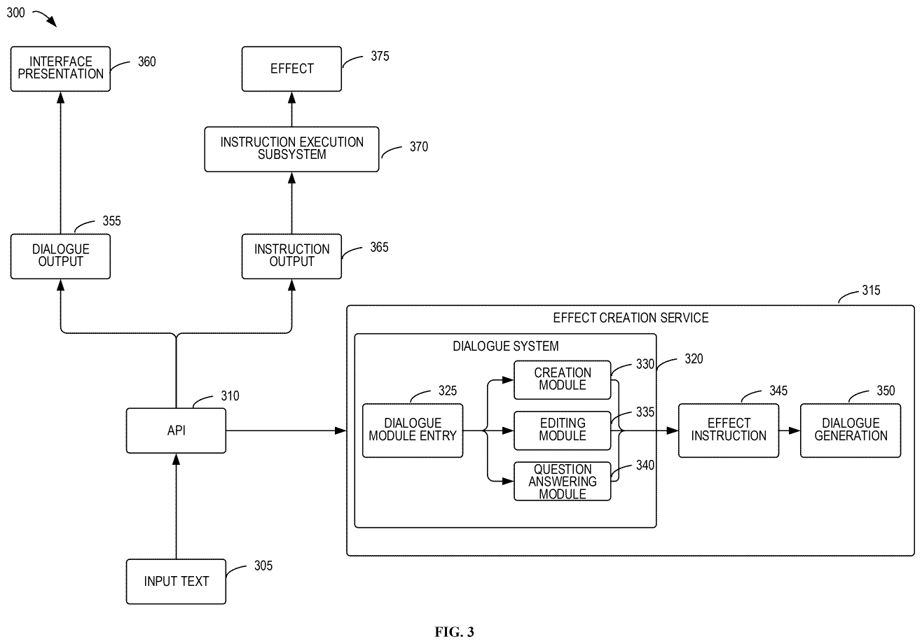

FIG. 3 shows an example effect creation system according to some embodiments of the present disclosure. As an example, the system 300 may be separately deployed at the electronic device 110 or the server 130 shown in FIG. 1, or the system 300 may also be jointly deployed at the electronic device 110 and the server device 130.

As shown in FIG. 3, the system 300 may obtain an input text 305 from a user and may use an application programming interface (API) 310 to invoke an effect creation service 315. As shown in the figure, the effect creation service 315 may include, for example, a dialogue system 320 that may process the input text 305 to generate corresponding response content.

As shown in the figure, a dialogue module entry 325 may determine a message type corresponding to the input text 305 and determine whether the input text 305 is to be processed by a creation module 330, an editing module 335 or a question answering module 340.

In some embodiments, the creation module 330, the editing module 335 and the question answering module 340 may be implemented based on an appropriate generative model. Different modules may have different model configuration information, for example, knowledge information or system prompts.

When it is being processed by the creation module 330 or the editing module 335, the creation module 330 or the editing module 335 may generate effect instructions (also referred to as commands) for creating an effect or editing an effect. These effect instructions may be executed by an effect application to create a new effect or edit an existing effect.

Further, the effect creation service 315 may generate corresponding response content, that is, a dialogue response, at block 350. Further, the dialogue response may be provided to the application via the API 310. In some scenarios, the dialogue response may include a dialogue input 355 and may be provided to the application for interface display at block 360.

In some other scenarios, the dialogue response may include an instruction output 365, which may be provided to an instruction execution subsystem 370 to create an effect 375 or edit an effect 375.

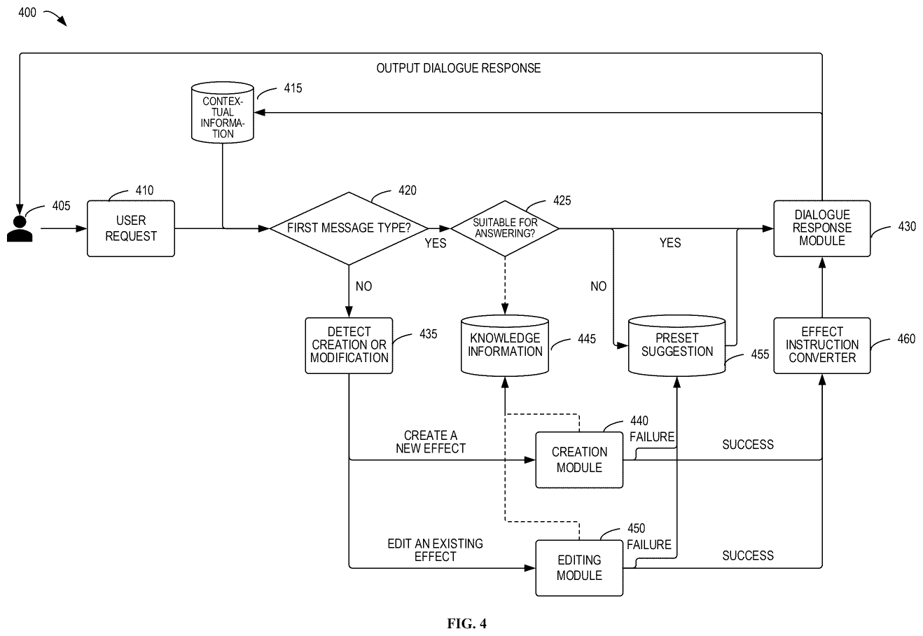

The specific process of processing the input text by the dialogue system 320 will be further described below in conjunction with FIG. 4.

As shown in FIG. 4, the dialogue system 320 may obtain a user request 410 from a user 405. The user request 410 may include an input message from the user 405.

Further, the dialogue system 320 may determine whether the user request 410 is associated with a first message type at block 420. As discussed above, the first message type may indicate that the input message from the user 405 includes a question to be answered. As shown in the figure, the dialogue system 320 may determine whether the user request 410 is associated with the first message type 420 in conjunction with the user request 410 and contextual information 415. The contextual information 415 may include, for example, historical chat information between the user and the virtual object.

If it is determined at block 420 that the user request 410 is associated with the first message type, the dialogue system 320 may further determine whether the question is suitable to be answered by a question answering module at block 425. In some embodiments, the dialogue system 420 may determine whether the question is suitable to be answered by the question answering module based on knowledge information 445. The knowledge information may include, for example, knowledge associated with effect creation, such as effect creation interfaces supporting invocation, specifications for effect creation, and the like.

As shown in the figure, if it is determined at block 425 that the question is suitable to be answered by the question answering module, the question answering module may generate response content for the question, where the response content includes an answer to the question. The response content may be provided to a dialogue response module 430 to provide a corresponding dialogue response to the user 405, for example, the answer to the user's question.

On the contrary, if it is determined at block 425 that the question is not suitable to be answered by the question answering module, the dialogue system may generate response content for the question based on a set of preset suggestions 455, where the response content includes a suggestion associated with the question input by the user. For example, the dialogue system may retrieve a suggestion associated with the question input by the user from the set of preset suggestions 455 and may generate corresponding response content accordingly. Similarly, the response content may be provided to the dialogue response module 430 to provide a corresponding dialogue response to the user 405, for example, a suggestion for the user's question.

Continuing to refer to FIG. 4, if it is determined that the user request 410 is not associated with the first message type 420, the dialogue system may detect at 435 whether the user request 410 is associated with an effect creation request or an effect modification request.

If it is determined at block 435 that the user request 410 indicates a request to create a new effect (i.e., the input message from the user is associated with the second message type), the creation module 440 may process the user request 410 based on the knowledge information 445 to generate corresponding effect creation code. The effect creation code may be provided to an effect instruction converter 460 to generate a set of effect instructions for creating the new effect. Accordingly, the set of effect instructions may be provided to the dialogue response module 430 to execute, by an effect application, the set of effect instructions to create the new effect, as a dialogue response to the user request 410.

On the contrary, if the creation module 440 fails to generate the effect creation code, the corresponding response content may be similarly generated based on the preset suggestions 455, for example, to suggest the user to optimize the input message.

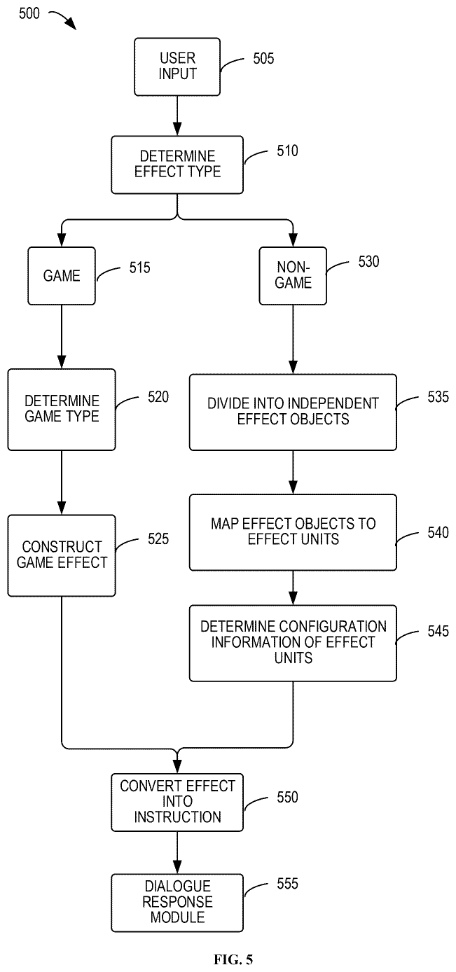

The specific processing procedure of the creation module 440 will be described in detail below with reference to FIG. 5.

On the contrary, if it is determined at block 435 that the user request 410 indicates an effect modification request (i.e., the input message from the user is associated with the third message type), the editing module 450 may process the user request 410 based on the knowledge information 445 to generate corresponding effect editing code. The effect editing code may be provided to the effect instruction converter 460 to generate a set of effect instructions for editing the new effect. Accordingly, the set of effect instructions may be provided to the dialogue response module 430 to execute, by the effect application, the set of effect instructions to edit the existing effect, as a dialogue response to the user request 410.

On the contrary, if the editing module 450 fails to generate the effect editing code, the corresponding response content may be similarly generated based on the preset suggestions 455, for example, to suggest the user to optimize the input message.

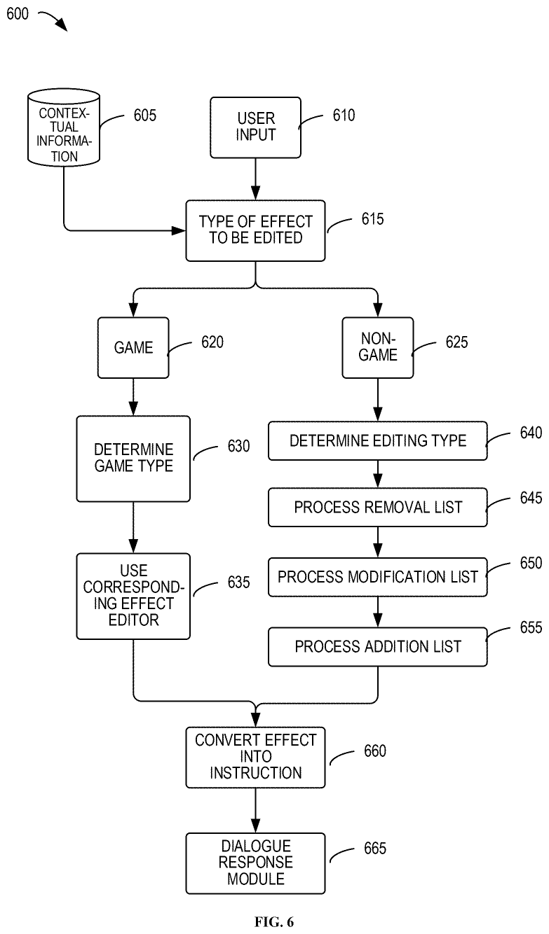

The specific processing procedure of the editing module 450 will be described in detail below with reference to FIG. 6.

### Example Effect Creation Process

An example process 500 of creating an effect will be described below with reference to FIG. 5. The process 500 may be performed by the creation module 440, for example.

As shown in FIG. 5, the creation module 440 may obtain a user input 505 and may determine an effect type of an effect to be created based on the user input 505 at block 510.

If the effect type is a game effect 515, the creation module 440 may use a first creation subsystem corresponding to the game effect to process the user input 505, thereby creating the game effect. Specifically, as shown in FIG. 5, the first creation subsystem may determine a game type corresponding to the game effect at block 520.

In some embodiments, the game effect may be pre-classified into multiple preset types, and different types may be associated with different creation links. As an example, the game type may include a 2D platform game, a 3D platform game, a maze game, and the like. The creation links corresponding to different game types may indicate that the generation logic and manner of the material in the game may be different.

Accordingly, the first creation subsystem may generate a corresponding game effect based on the creation link corresponding to the game type at block 525. For example, if the game type is a maze game, the first creation subsystem may use the creation link corresponding to the maze game to gradually generate various types of material in the maze game effect, thereby completing the creation of the maze game.

Further, the generated game effect may be converted into a set of effect instructions at block 550. The set of effect instructions may be further provided to the dialogue response module 555 for execution by an effect application to create the game effect locally.

On the contrary, if it is determined at block 510 that the effect type is a non-game effect 530, the creation module 440 may use a second creation subsystem corresponding to the non-game effect to process the user input 505, thereby creating the non-game effect. As an example, the non-game effect may include an effect of a type such as adding stickers.

Specifically, as shown in the figure, the second creation subsystem may determine an effect object to be created based on the input message at block 535. As an example, if the effect desired to be generated by the user is to add two kinds of sticker elements to the image, the second creation subsystem may divide the effect into two independent effect objects (i.e., sticker objects) at block 535.

Further, the second creation subsystem may correspondingly map the divided effect to a corresponding effect unit at block 540. The effect unit refers to a material unit that is allowed to be added or created in the effect application.

Further, the second creation subsystem may determine configuration information of an individual effect unit at block 545, for example, a specific material parameter of the material unit, such as color, position, motion parameter, and the like.

In this way, the second creation subsystem may iteratively complete the creation of an individual independent effect object, thereby completing the creation of the entire effect. Similarly, the generated effect may be converted into a set of effect instructions at block 550. The set of effect instructions may be further provided to the dialogue response module 555 for execution by an effect application to create the effect locally.

In this way, embodiments of the present disclosure are able to support the user to create different types of effects through chat interaction.

### Example Effect Editing Process

An example process 600 of creating an effect will be described below with reference to FIG. 6. The process 600 may be performed by the editing module 450, for example.

As shown in FIG. 6, the editing module 460 may obtain a user input 610 and contextual information 606 and may determine an effect type of an effect to be edited based on the user input 606 at block 616.

If the effect type is a game effect 660, the editing module 450 may use a first sub-editing system corresponding to the game effect to process the user input 610, thereby editing the game effect. Specifically, as shown in FIG. 6, the first sub-editing system may determine a game type corresponding to the game effect at block 620.

In some embodiments, the game effect may be pre-classified into multiple preset types, and different types may be associated with different game editors. As an example, the game type may include a 2D platform game, a 3D platform game, a maze game, and the like. Different game editors may indicate game parameters that are allowed to be edited in different game effects.

Accordingly, the first sub-editing system may edit an existing game effect using the game editor corresponding to the game type at block 635. For example, if the game type is a maze game, the first sub-editing system may use the game editor corresponding to the maze game to edit specified parameters in the maze game.

Further, the generated game effect may be converted into a set of effect instructions at block 660. The set of effect instructions may be further provided to the dialogue response module 665 for execution by an effect application to edit the game effect locally.

On the contrary, if it is determined at block 615 that the effect type is a non-game effect 625, the editing module 450 may use a second sub-editing system corresponding to the non-game effect to process the user input 610, thereby editing the non-game effect.

The second editing subsystem is configured to determine an editing type based on the user input 610 at block 640. In some embodiments, the editing type may include adding an effect unit, removing an effect unit, or modifying an effect unit.

As an example, the second editing subsystem may determine a removal list, a modification list, and an addition list based on the input message and may sequentially process the removal list at block 645, process the modification list at block 650, and process the addition list 655 at block 655.

In this way, the second sub-editing system may iteratively complete the editing (for example, addition, removal, or modification) of each object unit, thereby completing the editing of the entire effect. Similarly, the output content of the model may be converted into a set of effect instructions corresponding to the editing type at block 660. The set of effect instructions may be further provided to the dialogue response module 665 for execution by an effect application to edit the effect locally.

In this way, the embodiments of the present disclosure are able to support the user to edit different types of effects through chat interaction.

### Example Process

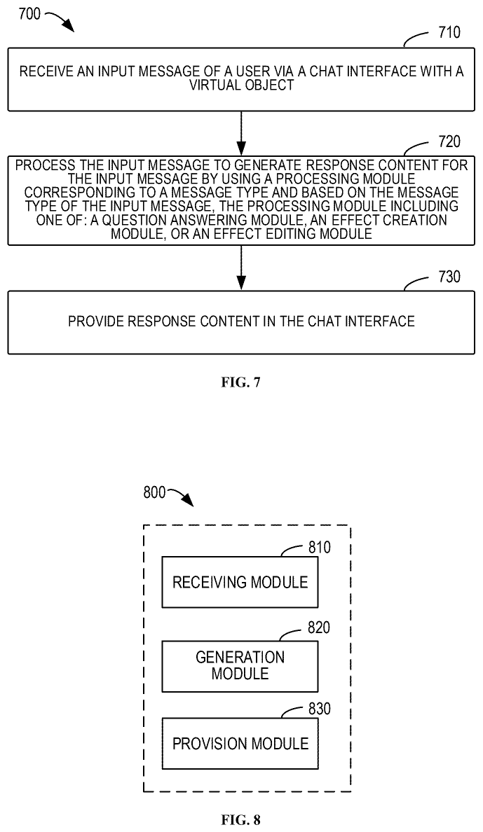

FIG. 7 shows a flowchart of an example process 700 of effect creation according to some embodiments of the present disclosure. The process 700 may be implemented at the electronic device 110 or the system 300.

As shown in the figure, at block 710, the system 300 receives an input message of a user via a chat interface with a virtual object.

At block 720, the system 300 processes, based on a message type of the input message and by using a processing module corresponding to the message type, the input message to generate response content for the input message, the processing module includes one of: a question answering module, an effect creation module, or an effect editing module.

At block 730, the system 300 provides the response content in the chat interface.

In some embodiments, processing, based on the message type of the input message and by using the processing module corresponding to the message type, the input message includes: processing, in response to the message type being a first message type and by using the question answering module, the input message to generate the response content for the input message, the first message type indicating that the input message includes a question to be replied.

In some embodiments, the question answering module is configured to generate, in response to determining that the question answering module is suitable for answering the question in the input message, the response content for the question, the response content includes an answer to the question; or generate, in response to determining that the question answering module is not suitable for answering the question in the input message, the response content for the question based on a set of preset suggestions, the response content includes a suggestion associated with the question.

In some embodiments, processing, based on the message type of the input message and by using the processing module corresponding to the message type, the input message includes: processing, in response to the message type being a second message type and by using the effect creation module, the input message to generate the response content for the input message, the second message type indicating that the input message is associated with an effect creation request.

In some embodiments, the effect creation module is configured to determine, based on the input message, a first effect type of an effect to be created, the first effect type includes a game effect or a non-game effect; and process, by using a creation subsystem corresponding to the first effect type, the input message to generate a first effect.

In some embodiments, the first creation subsystem corresponding to the game effect is configured to: determine a game type corresponding to the game effect; and generate the first effect by using a creation link corresponding to the game type.

In some embodiments, the second creation subsystem corresponding to the non-game effect is configured to determine an effect object to be created based on the input message; determine at least one effect unit associated with the effect object from a set of preset effect units; and determine configuration information of the at least one effect unit.

In some embodiments, processing, based on the message type of the input message and by using the processing module corresponding to the message type, the input message includes: processing, in response to the message type being a third message type and by using the effect editing module, the input message to generate a set of editing instructions, the third message type indicating that the input message is associated with an effect editing request; and executing the set of editing instructions to determine the response content for the input message.

In some embodiments, the effect creation module is configured to determine a second effect type of an effect to be edited based on the input message, the second effect type includes a game effect or a non-game effect; and process, by using an editing subsystem corresponding to the second effect type, the input message to generate the set of editing instructions for the second effect.

In some embodiments, the first editing subsystem corresponding to the game effect is configured to determine a game type corresponding to the game effect; and generate, by using a game editor corresponding to the game type, the set of editing instructions.

In some embodiments, the second editing subsystem corresponding to the non-game effect is configured to determine an editing type based on the input message, the editing type includes at least one of: adding an effect unit, removing an effect unit, or modifying an effect unit; and generate the set of editing instructions corresponding to the editing type.

In some embodiments, the response content is further generated based on at least one of: contextual information associated with the chat interface; or knowledge information associated with effect editing.

### Example Apparatus and Device

Embodiments of the present disclosure further provide a corresponding apparatus for implementing the above method or process. FIG. 8 shows a schematic structural block diagram of an example apparatus 800 for effect creation according to some embodiments of the present disclosure. The apparatus 800 may be implemented as or included in the electronic device 110 or the system 300. Each module/component in the apparatus 800 may be implemented by hardware, software, firmware, or any combination thereof.

As shown in FIG. 8, the apparatus 800 includes a receiving module 810 configured to receive an input message of a user via a chat interface with a virtual object; a generation module 820 configured to process, based on a message type of the input message and by using a processing module corresponding to the message type, the input message to generate response content for the input message, the processing module includes one of: a question answering module, an effect creation module, or an effect editing module; and a provision module 830 configured to provide the response content in the chat interface.

In some embodiments, processing, based on the message type of the input message and by using the processing module corresponding to the message type, the input message includes: processing, in response to the message type being a first message type and by using the question answering module, the input message to generate the response content for the input message, the first message type indicating that the input message includes a question to be replied.

In some embodiments, the question answering module is configured to generate, in response to determining that the question answering module is suitable for answering the question in the input message, the response content for the question, the response content includes an answer for the question; or generate, in response to determining that the question answering module is not suitable for answering the question in the input message, the response content for the question based on a set of preset suggestions, the response content includes a suggestion associated with the question.

In some embodiments, processing, based on the message type of the input message and by using the processing module corresponding to the message type, the input message includes: processing, in response to the message type being a second message type and by using the effect creation module, the input message to generate the response content for the input message, the second message type indicating that the input message is associated with an effect creation request.

In some embodiments, the effect creation module is configured to determine, based on the input message, a first effect type of an effect to be created, the first effect type includes a game effect or a non-game effect; and process, by using a creation subsystem corresponding to the first effect type, the input message to generate a first effect.

In some embodiments, the first creation subsystem corresponding to the game effect is configured to determine a game type corresponding to the game effect; and generate the first effect by using a creation link corresponding to the game type.

In some embodiments, the second creation subsystem corresponding to the non-game effect is configured to determine an effect object to be created based on the input message; determine at least one effect unit associated with the effect object from a set of preset effect units; and determine configuration information of the at least one effect unit.

In some embodiments, processing, based on the message type of the input message and by using the processing module corresponding to the message type, the input message includes: processing, in response to the message type being a third message type and by using the effect editing module, the input message to generate a set of editing instructions, the third message type indicating that the input message is associated with an effect editing request; and executing the set of editing instructions to determine the response content for the input message.

In some embodiments, the effect creation module is configured to determine a second effect type of an effect to be edited based on the input message, the second effect type includes a game effect or a non-game effect; and process, by using an editing subsystem corresponding to the second effect type, the input message to generate the set of editing instructions for the second effect.

In some embodiments, the first editing subsystem corresponding to the game effect is configured to determine a game type corresponding to the game effect; and generate, by using a game editor corresponding to the game type, the set of editing instructions.

In some embodiments, the second editing subsystem corresponding to the non-game effect is configured to determine an editing type based on the input message, the editing type includes at least one of: adding an effect unit, removing an effect unit, or modifying an effect unit; and generate the set of editing instructions corresponding to the editing type.

In some embodiments, the response content is further generated based on at least one of: contextual information associated with the chat interface; or knowledge information associated with effect editing.

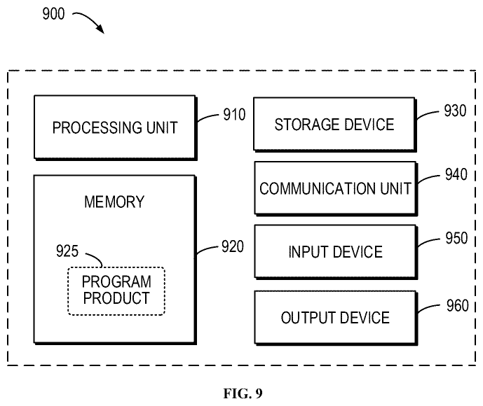

FIG. 9 shows a block diagram of an electronic device 900 in which one or more embodiments of the present disclosure may be implemented. It would be appreciated that the electronic device 900 shown in FIG. 9 is only illustrative and should not constitute any limitation to the functions and scope of the embodiments described herein. The electronic device 900 shown in FIG. 9 may be used to implement the electronic device 110 in FIG. 1 or the system 300 in FIG. 3.

As shown in FIG. 9, the electronic device 900 is in the form of a general-purpose electronic device. The components of the electronic device 900 may include but are not limited to one or more processors or processing units 910, a memory 920, a storage device 930, one or more communication units 940, one or more input devices 950 and one or more output devices 960. The processing unit 910 may be an actual or virtual processor and may execute various processes based on the programs stored in the memory 920. In a multi-processor system, multiple processing units execute computer executable instructions in parallel to improve the parallel processing capability of the electronic device 900.

The electronic device 900 typically includes multiple computer storage medium. Such medium may be any available medium that is accessible to the electronic device 900, including but not limited to volatile and non-volatile medium, removable and non-removable medium. The memory 920 may be a volatile memory (for example, a register, a cache, a random access memory (RAM)), a non-volatile memory (such as a read-only memory (ROM), an electrically erasable programmable read-only memory (EEPROM), a flash memory), or any combination thereof. The storage device 930 may be any removable or non-removable medium, and may include a machine-readable medium such as a flash drive, a disk, or any other medium, which may be used to store information and/or data and may be accessed within the electronic device 900.

The electronic device 900 may further include additional removable/non-removable, volatile/non-volatile memory medium. Although not shown in FIG. 9, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 920 may include a computer program product 925, which has one or more program modules configured to perform various methods or acts of the various embodiments of the present disclosure.

The communication unit 940 implements communication with other electronic devices through the communication medium. Additionally, the functions of the components of the electronic device 900 may be implemented by a single computing cluster or multiple computing machines, which may communicate through communication connections. Therefore, the electronic device 900 may use a logical connection with one or more other servers, network personal computers (PCs) or another network node to operate in a networked environment.

The input device 950 may be one or more input devices, such as a mouse, a keyboard, a tracking ball, etc. The output device 960 may be one or more output devices, such as a display, a speaker, a printer, etc. The electronic device 900 may also communicate with one or more external devices (not shown) as needed through the communication unit 940, the external devices such as a storage device, a display device, etc., communicate with one or more devices that enable the user to interact with the electronic device 900, or communicate with any device (such as a network card, a modem, etc.) that enables the electronic device 900 to communicate with one or more other electronic devices. Such communication may be performed via input/output (I/O) interfaces (not shown).

According to an illustrative implementation of the present disclosure, there is provided a computer-readable storage medium having computer executable instructions stored thereon, where the computer executable instructions are executed by a processor to implement the method described above. According to an illustrative implementation of the present disclosure, there is further provided a computer program product tangibly stored on a non-transitory computer-readable medium and including computer executable instructions, which are executed by a processor to implement the method described above.

Various aspects of the present disclosure are described herein with reference to the flowcharts and/or block diagrams of the method, apparatus, device and computer program product implemented according to the present disclosure. It would be appreciated that each block of the flowchart and/or block diagram, and combinations of blocks in the flowchart and/or block diagram, may be implemented by computer-readable program instructions.

These computer-readable program instructions may be provided to the processing unit of a general-purpose computer, a special-purpose computer, or other programmable data processing apparatus to produce a machine, such that when these instructions are executed by the processing unit of the computer or other programmable data processing apparatus, an apparatus for implementing the functions/actions specified in one or more blocks of the flowchart and/or block diagram is produced. These computer-readable program instructions may also be stored in a computer-readable storage medium, these instructions cause the computer, the programmable data processing apparatus and/or other devices to work in a specific manner, and thus, the computer-readable medium having the instructions stored thereon includes a manufactured product, which includes instructions for implementing various aspects of the functions/actions specified in one or more blocks of the flowchart and/or block diagram.

The computer-readable program instructions may be loaded onto a computer, other programmable data processing apparatus, or other devices, so that a series of operation steps are performed on the computer, other programmable data processing apparatus or other devices to produce a computer-implemented process, which makes the instructions executed on the computer, other programmable data processing apparatus, or other devices implement the functions/actions specified in one or more blocks of the flowchart and/or block diagram.

The flowchart and block diagram in the drawings show the possibly implemented architectures, functions and operations of the system, method and computer program product according to multiple implementations of the present disclosure. In this regard, each block in the flowchart or block diagram may represent a module, program segment or part of instruction, and the module, program segment or part of instruction contains one or more executable instructions for implementing the specified logical functions. In some alternative implementations, the functions marked in the blocks may also occur in an order different from that marked in the drawings. For example, two consecutive blocks may actually be executed substantially in parallel, or they may sometimes be executed in the reverse order, depending on the functions involved. It should also be noted that each block in the block diagram and/or the flowchart, and the combination of the blocks in the block diagram and/or the flowchart may be implemented by a dedicated hardware-based system that executes specified functions or actions, or may be implemented by a combination of dedicated hardware and computer instructions.

The implementations of the present disclosure have been described above, and the above description is illustrative, non-exhaustive, and not limited to the disclosed implementations. Without departing from the scope of the illustrated implementations, many modifications and changes will be apparent to those of ordinary skill in the art. The terms used herein are selected to best explain the principles of the implementations, the practical applications or improvements to the technologies in the market, or to enable other ordinary skilled persons in the art to understand the implementations disclosed herein.

1. A method for effect creation, comprising:
receiving an input message of a user via a chat interface with a virtual object;
processing, based on a message type of the input message and by using a processing module corresponding to the message type, the input message to generate response content for the input message, the processing module comprising one of: a question answering module, an effect creation module, or an effect editing module; and
providing the response content in the chat interface.

2. The method of claim 1, wherein processing, based on the message type of the input message and by using the processing module corresponding to the message type, the input message comprises:
processing, in response to the message type being a first message type and by using the question answering module, the input message to generate the response content for the input message, the first message type indicating that the input message comprises a question to be replied.

3. The method of claim 2, wherein the question answering module is configured to:
generating, in response to determining that the question answering module is suitable for answering the question in the input message, the response content for the question, the response content comprising an answer for the question; or
generating, in response to determining that the question answering module is not suitable for answering the question in the input message, the response content for the question based on a set of preset suggestions, the response content comprising a suggestion associated with the question.

4. The method of claim 1, wherein processing, based on the message type of the input message and by using the processing module corresponding to the message type, the input message comprises:
processing, in response to the message type being a second message type and by using the effect creation module, the input message to generate the response content for the input message, the second message type indicating that the input message is associated with an effect creation request.

5. The method of claim 4, wherein the effect creation module is configured to:
determine, based on the input message, a first effect type of an effect to be created, the first effect type comprising a game effect or a non-game effect; and
process, by using a creation subsystem corresponding to the first effect type, the input message to generate a first effect.

6. The method of claim 5, wherein the first creation subsystem corresponding to the game effect is configured to:
determine a game type corresponding to the game effect; and
generate the first effect by using a creation link corresponding to the game type.

7. The method of claim 5, wherein the second creation subsystem corresponding to the non-game effect is configured to:
determine an effect object to be created based on the input message;
determine at least one effect unit associated with the effect object from a set of preset effect units; and
determine configuration information of the at least one effect unit.

8. The method of claim 1, wherein processing, based on the message type of the input message and by using the processing module corresponding to the message type, the input message comprises:
processing, in response to the message type being a third message type and by using the effect editing module, the input message to generate a set of editing instructions, the third message type indicating that the input message is associated with an effect editing request; and
executing the set of editing instructions to determine the response content for the input message.

9. The method of claim 8, wherein the effect creation module is configured to:
determine a second effect type of an effect to be edited based on the input message, the second effect type comprising a game effect or a non-game effect; and
process, by using an editing subsystem corresponding to the second effect type, the input message to generate the set of editing instructions for the second effect.

10. The method of claim 9, wherein the first editing subsystem corresponding to the game effect is configured to:
determine a game type corresponding to the game effect; and
generate, by using a game editor corresponding to the game type, the set of editing instructions.

11. The method of claim 9, wherein the second editing subsystem corresponding to the non-game effect is configured to:
determine an editing type based on the input message, the editing type comprising at least one of: adding an effect unit, removing an effect unit, or modifying an effect unit; and
generate the set of editing instructions corresponding to the editing type.

12. The method of claim 1, wherein the response content is further generated based on at least one of:
contextual information associated with the chat interface; or
knowledge information associated with effect editing.

13. An electronic device, comprising:
at least one processor; and
at least one memory, the at least one memory being coupled to the at least one processor and storing instructions executable by the at least one processor, the instructions, when executed by the at least one processor, causing the electronic device to perform operations comprising:
receiving an input message of a user via a chat interface with a virtual object;
processing, based on a message type of the input message and by using a processing module corresponding to the message type, the input message to generate response content for the input message, the processing module comprising one of: a question answering module, an effect creation module, or an effect editing module; and
providing the response content in the chat interface.

14. The electronic device of claim 13, wherein processing, based on the message type of the input message and by using the processing module corresponding to the message type, the input message comprises:
processing, in response to the message type being a first message type and by using the question answering module, the input message to generate the response content for the input message, the first message type indicating that the input message comprises a question to be replied.

15. The electronic device of claim 14, wherein the question answering module is configured to:
generating, in response to determining that the question answering module is suitable for answering the question in the input message, the response content for the question, the response content comprising an answer for the question; or
generating, in response to determining that the question answering module is not suitable for answering the question in the input message, the response content for the question based on a set of preset suggestions, the response content comprising a suggestion associated with the question.

16. The electronic device of claim 13, wherein processing, based on the message type of the input message and by using the processing module corresponding to the message type, the input message comprises:
processing, in response to the message type being a second message type and by using the effect creation module, the input message to generate the response content for the input message, the second message type indicating that the input message is associated with an effect creation request.

17. The electronic device of claim 16, wherein the effect creation module is configured to:
determine, based on the input message, a first effect type of an effect to be created, the first effect type comprising a game effect or a non-game effect; and
process, by using a creation subsystem corresponding to the first effect type, the input message to generate a first effect.

18. The electronic device of claim 17, wherein the first creation subsystem corresponding to the game effect is configured to:
determine a game type corresponding to the game effect; and
generate the first effect by using a creation link corresponding to the game type.

19. The electronic device of claim 17, wherein the second creation subsystem corresponding to the non-game effect is configured to:
determine an effect object to be created based on the input message;
determine at least one effect unit associated with the effect object from a set of preset effect units; and
determine configuration information of the at least one effect unit.

20. A computer program product being tangibly embodied on a non-transitory computer-readable storage medium and comprising instructions that, when executed by at least one computing device, are configured to cause the at least one computing device the to perform operations comprising:
receiving an input message of a user via a chat interface with a virtual object;
processing, based on a message type of the input message and by using a processing module corresponding to the message type, the input message to generate response content for the input message, the processing module comprising one of: a question answering module, an effect creation module, or an effect editing module; and
providing the response content in the chat interface.
